(19) United States
(12) Patent Application Publication
(10) Pub. No.: US 2009/0100348 A1
(43) Pub. Date: Apr. 16, 2009

(54) Warning method during content modification and system therefor

(75) Inventors: Laurent Castaignet, Paris (FR); Thierry Moudenc, Perros Guirec (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/918,787

(22) PCT Filed: Apr. 4, 2006
(86) PCT No.: PCT/FR2006/000737

§ 371 Date: Dec. 6, 2007

(30) Foreign Application Priority Data
Apr. 19, 2005 (FR) 05 03922

(51) Int. Cl. G06F 3/00

(52) U.S. Cl. 715/751

(57) ABSTRACT

The invention concerns a method for warning a user (17) equipped with a terminal (4, 5, 6, 67) during modification of a content in accordance with a content syndication technology in a communication system supporting a session initiation protocol and including a warning server (1) and a content server (2). The method is characterized in that it consists in: transmitting, from a terminal (4) of the user (17) to the warning server (1), a subscription message (9, 18) of said protocol identifying a content in conformity with said content syndication technology stored on the content server (2); receiving at the warning server (1), from the content server (2), an indication concerning a modification of said content; and transmitting a notifying message (11, 10, 23) of said protocol to said user (17), from the warning server (1), when an indication concerning a modification of said content has been received.

The present invention relates to a warning mechanism on a modification of an information content in a communication system.

There is currently a trend towards a popularization and an increasing dissemination of so-called “content syndication” technologies, including, for example, the RSS (Really Simple Syndication) and Atom standards. These two XML (extensible Markup Language) dialects provide for the structured description of the content of a web site in terms of articles, by including in particular elements such as title, description and hypertext link to the full text. Hereinafter, the RSS technology will be more particularly considered, although the explanation is entirely applicable to the Atom technology and to any other content syndication technology.

The applications of the content syndication technologies range notably from the referencing of content from one site to another to the aggregation of the content of different sites from dedicated reader software (“RSS reader”, for example). Very popular in the context of personal weblogs, these technologies are also naturally applicable in the field of online news publication.

Currently, the RSS readers operate in polling mode. Thus, for a given RSS information source (RSS feed), an HTTP (HyperText Transfer Protocol) request is periodically sent from each interested client to a target RSS server on which the feed is stored, via a communication network, in order to obtain indications on any update of the feed. The reader applies a local display strategy according to the information that is fed to it in this way, and, if necessary, the consultation history of the user of the reader (a grayed-out font for articles that have already been read, for example).

Because of the HTTP requests that are periodically sent, this mode of operation imposes an unnecessary load on the client, the server and the network itself. This state of affairs also leads most servers hosting an RSS data feed to limit the rate at which this feed is updated, which runs counter to the dynamic nature expected, for example, in the case of an online news site.

Furthermore, personal mobility is not supported in this model. In practice, the reception of information is conditional on the availability of an RSS reader on the terminal used, which excludes a large number of terminals. Thus, a person may very well be warned of the updates of a content when using a terminal provided with an RSS reader, but no longer be warned when using another terminal.

Another problem posed by the known consultation and warning mechanisms using content syndication technologies is that they are not always compatible with the basic properties of the communication networks in which they are operating.

In particular, the networks supporting the session initiation and notification protocol SIP (Session Initiation Protocol) like certain VoIP (Voice over IP) networks have emerged under the impetus of standardization groups such as the IETF (Internet Engineering Task Force) or 3GPP (3rd Generation Partnership Project), and are about to be widely rolled out. These networks support basic services such as conventional interpersonal communications (audio and video calls, media broadcast, and so on), the concepts of personal mobility, presence and availability, etc. Now, there is currently no mechanism for implementing a warning service permitted by the content syndication technologies on such SIP networks, which is compatible with the basic properties offered by this type of network.

Proposals have attempted to improve the situation, without, however, overcoming all the abovementioned drawbacks. For example, the latest version of the RSS technology, namely RSS 2.0, offers the possibility of operation in selective distribution mode (“push” mode), relying on a subscription and notification mechanism (XML-RPC or SOAP). This solution can be used to lighten the network load and immediately benefit from an update occurring on an RSS feed. It does, however, present a certain number of drawbacks, including the inability to pass through the firewalls and the network address translators (NAT) that are widely used in data networks. Moreover, it does not support personal mobility.

One object of the present invention is to reduce the drawbacks of the known techniques.

In particular, one object of the invention is to propose a warning mechanism relating to a content syndication technology in a communication system supporting a session initiation and notification protocol.

The invention thus proposes a method for warning a user provided with at least one terminal on modification of a content conforming to a content syndication technology in a communication system supporting a session initiation and notification protocol and including a warning server and a content server. This method comprises the following steps:
transmitting, from a terminal of the user to the warning server, a subscription message of said protocol, said subscription message identifying a content conforming to said content syndication technology stored on the content server;
receiving on the warning server, from the content server, an indication relating to a modification of said content; and
transmitting a notification message of said protocol to said user, from the warning server, when the warning server has received an indication relating to a modification of said content.

The use of subscription and notification messages of the session initiation and notification protocol makes it possible to warn the user of updates of the content conforming to said syndication technology.

Furthermore, it renders the warning relating to the content according to said content syndication technology compatible with the basic principles of the communication system supporting the session initiation and notification protocol. This makes it possible in particular to implement the warning mechanism while benefiting from personal mobility and the concepts of presence and availability as provided for in the session initiation and notification protocol.

Furthermore, such a method makes it possible to warn the user only when this is necessary, that is, on modifications of the content in which he is interested. The load problems mentioned in the introduction are thus avoided, at least between the user and the warning server. The user is, however, informed of all updates of the content, which is in line with the dynamic nature expected for certain data feeds.

Advantageously, the notification message is transmitted to the user via at least one of his terminals, the transmission being suited to the capabilities of this or these terminals, depending, for example, on whether the terminal supports the SIP protocol's event package concept.

The invention also proposes a communication system supporting a session initiation and notification protocol, comprising a warning server able to communicate with at least one user provided with at least one terminal and a content server able to store at least one content conforming to a content syndication technology. The communication system also comprises:
means for receiving on the warning server, from a terminal of the user, a subscription message of said protocol, said subscription message identifying a content conforming to said content syndication technology stored on the content server;
means for receiving on the warning server, from the content server, an indication relating to a modification of said content; and
means for transmitting a notification message of said protocol to said user, from the warning server, when the warning server has received an indication relating to a modification of said content.

The invention also proposes a warning server supporting a session initiation and notification protocol comprising:
means for receiving, from a terminal of a user, a subscription message of said protocol, said subscription message identifying a content conforming to a content syndication technology stored on a content server;
means for receiving, from the content server, an indication relating to a modification of said content; and
means for transmitting a notification message of said protocol to said user when said warning server has received an indication relating to a modification of said content.

The invention also proposes a computer program able to be implemented on a warning server, said computer program comprising code instructions which, when run on said warning server, performs the following steps:
receiving, from a terminal of a user, a subscription message of said protocol, said subscription message identifying a content conforming to a content syndication technology stored on a content server;
receiving, from the content server, an indication relating to a modification of said content; and
transmitting a notification message of said protocol to said user when said warning server has received an indication relating to a modification of said content.

Other features and advantages of the present invention will become apparent from the description below of exemplary but non-exclusive embodiments, with reference to the appended drawings, in which:

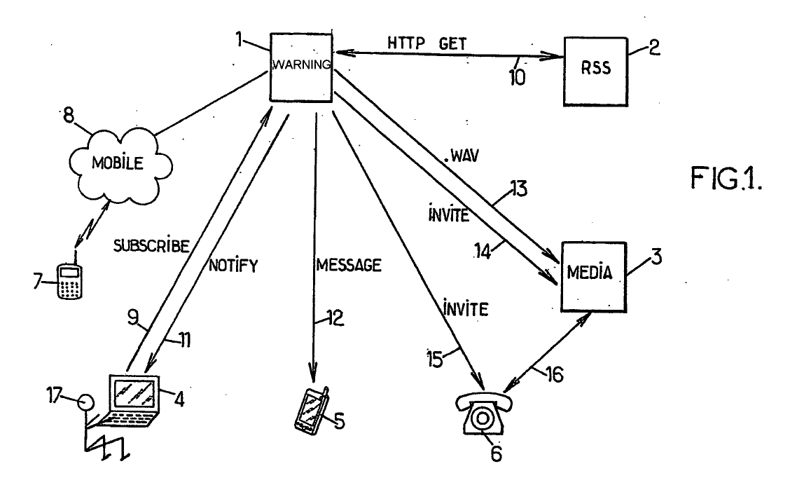

FIG. 1 is a simplified architecture diagram of a communication system in which the invention can be implemented; and

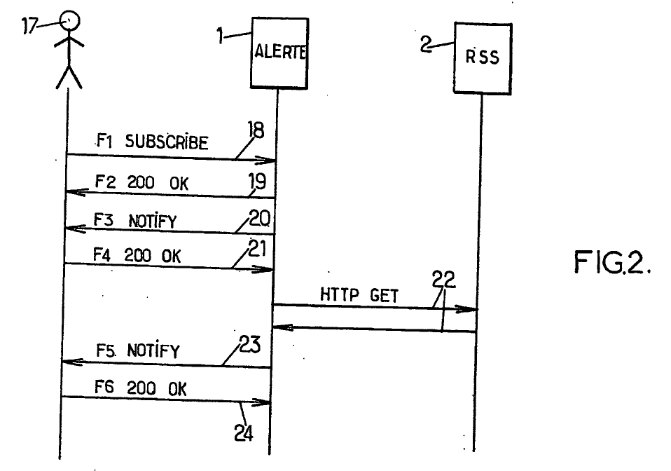

FIG. 2 is a diagram showing a message stream interchange according to one embodiment of the invention.

FIG. 1 shows a communication system comprising a warning server 1 and an RSS content server 2. This system is, for example, a VoIP network. It supports the session initiation and notification protocol SIP as defined in recommendation RFC 3261 published in June 2002 by the IETF.

In this example, the server 2 contains content feeds conforming to the RSS technology. However, a content server according to the Atom technology or any other content syndication technology could also be considered.

The warning server 1 is able to communicate with the RSS content server 2, as detailed hereinafter. Furthermore, a user 17 can communicate with the warning server 1 of the communication system, in order in particular to be warned of any modification of a certain RSS content stored on the server 2.

To this end, the user 17 is provided with a terminal which can be of different types. For example, the terminal can be a computer 4 having means for communicating with the communication system, for example via a conventional Internet connection. It can also be a personal digital assistant (PDA) 5, a conventional wired telephone 6 or a cell phone 7. In the latter case, the user 17 communicates with the warning server 1 via appropriate communication means, in particular a wireless access mobile network 8, for example according to the GSM (Global System for Mobile communications), GPRS (General Packet Radio Service) or UMTS (Universal Mobile Telecommunications System) technology.

The terminal with which the user 17 is provided has an SIP client so as to operate coherently with the communication system which is an SIP network. Advantageously, it also has an RSS reader, possibly incorporated in the SIP client, which enables it to use the RSS content that reaches it from the server 2 as will be detailed hereinafter.

The SIP protocol offers a generic event mechanism which can be dedicated to a particular need and that is exploited by the present invention. This mechanism is detailed in recommendation RFC 3265, “Session Initiation Protocol (SIP)—Specific Event Notification”, published in June 2002 by the IETF. It defines in particular the concept of event package (to use the terminology defined in RFC 3265) which corresponds to a set of status information to be reported by a notifier to a subscriber. The event package also uses a specific syntax and semantics for the transmission of the status information (see in particular section 2 of the abovementioned RFC 3265).

According to the invention, an event package is used to subscribe to a given RSS stream and be informed of a modification of the content referenced by this stream. Thus, in the example illustrated in FIG. 1, the user 17 can subscribe to an RSS stream stored on the RSS content server 2.

To this end, the user 17 transmits a subscription message 9 (SUBSCRIBE) according to the abovementioned RFC 3265, from his terminal 4 and to the warning server 1. This message contains in particular one or more identifiers URI (Uniform Resource Identifier) pointing to the RSS stream to which the user wants to subscribe.

The warning server 1 is responsible for interrogating the target RSS server 2. The relationship between the warning server 1 and the RSS content server 2 can take different forms according to the load constraints of the network and the capabilities of the servers. As an example, the warning server 1 can interrogate the RSS server 2 using an HTTP GET message, that is, a message of the HTTP protocol including the URI identifier or identifiers pointing to the targeted RSS stream. In this case, the RSS server 2 returns the desired updated RSS content to the warning server 1, according to the same mode (message 10 in FIG. 1). Naturally, other interchange modes between the servers 1 and 2 are also possible to obtain the update information on the warning server 1 (conditional GET, XML-RPC for example, as specified by the RSS 2.0 standard, and so on).

In response to the subscription and each time the stream targeted by the subscription is updated, a notification message 11 (NOTIFY) conforming to the abovementioned RFC 3265 transmits to the user 17 all or part of the updated content. The user 17 can then use the updated content, in particular when he is using a terminal 4 provided with a dedicated RSS reader.

It will be noted that the concept of subscription is linked to a user of the SIP network (designated by an identifier, for example, of the type “sip:user@example.com”) and not to the terminal from which the subscription has been made. This makes it possible in particular to exploit the possibilities of the SIP protocol in terms of personal mobility (the user being able to use different terminals), expression of the presence and of the availability to deliver notifications suited to the context.

The warning server can decide on a notification strategy suited to the capabilities of the target terminal, in particular if the user has changed terminal since the subscription. The capabilities of the terminal can include the protocols managed such as the SIP protocol or a part of SIP or even mobile network protocols for example, the messages within this protocol (therefore the subset of the protocol), the media capabilities (audio, video, etc.), and so on.

As an illustration, in the example represented in FIG. 1, the notification made by the warning server 1 uses the NOTIFY message 11 when the user 17 uses the computer 4 as his terminal.

On the other hand, if a personal digital assistant 5 not supporting the concept of warning event package as defined in RFC 3265 is used by the user 17, the notification can then take the form of an instant message 12 (MESSAGE) of the SIP protocol.

Similarly, if a telephone 6 not supporting the concept of warning event package of RFC 3265 is used by the user 4, the warning server 1 advantageously transmits, in voice form, the content that it has received from the RSS content server 2 to a media server 3. This spoken content consists, for example, of a sound file of any predetermined format (for example .wav in the message 13 in FIG. 1). The warning server 1 then transmits a call message (INVITE) as defined in the abovementioned RFC 3261 to each of the media server 3 (message 13) and the telephone 6 (message 15). In response to these messages, the media server 3 broadcasts the spoken content in voice synthesis mode (reference 16), so that the telephone 6 can have the updated content in a manner suited to its capabilities.

In the particular case where the user 17 is provided with a mobile terminal 7, the mechanism described above is applied. However, the messages exchanged between the terminal 7 and the warning server 1 pass through the mobile network 8. Appropriate gateways are then used to ensure the routing between the pure SIP network and the mobile network 8. Among the possibilities that can be considered, the messages can be transmitted over the network 8 using SMS (Short Message Service) type short messages or pages sent in “WAP push” mode.

FIG. 2 shows in a little more detail certain interchanges implemented on subscription to and distribution of content according to one embodiment of the invention. The SIP interchanges associated with the presence, the availability and the capabilities of the terminals are not represented, because they conform to the SIP model defined by the IETF, in particular the abovementioned RFC 3261 and 3265, and RFC 3856, “A Presence Event Package for the Session Initiation (SIP)”, published in August 2004 by the IETF. In particular, the warning server 1 acts as “registrar” and “presence server” as defined in this model. This enables it to take decisions concerning the routing of the notifications and their adaptation to the target terminal.

It will be seen from FIG. 2 that the subscription message 18 (SUBSCRIBE) and the notification message 20 (NOTIFY) are acknowledged by the user 17, via his terminal, and by the warning server 1 respectively (“OK” messages 19 and 21).

A second notification message 23 is transmitted from the warning server 1 to the user 17, after the server 1 has received, from the RSS server 2, a content update indication corresponding to the subscription. This second notification message 23 is also the subject of an acknowledgement 24.

As described above, the RSS subscription and notification messages 18, 20 and 23 conform to a specific event package. The subscription message 18 transmitted to the warning server 1 contains one or several URI identifiers, each pointing to an RSS resource. The notification messages 20 and 23 transport the RSS content recovered from the server 2.

The subscription message 18 can, for example, include the following information:

F1 SUBSCRIBE subscriber->example.com server
SUBSCRIBE sip:alerts@example.com SIP/2.0
Via: SIP/2.0/UDP subscriberhost.example.com;branch=z9hG4bKnashds7
To: <sip:alerts@example.com>
From: <sip:user@example.com>;tag=xfg9
Call-ID: 1564@subscriberhost.example.com
CSeq: 19766 SUBSCRIBE
Max-Forwards: 70
Event: alerting
Accept: application/rss+xml
Contact: <sip:user@subscriberhost.example.com>
Expires: 3600
Content-Type: text/uri-list
Content-Length: . . .
http://www.zdnet.fr/headlines.rss

Similarly, the notification message 20 can, for example, include the following information:

F3 NOTIFY example.com server->subscriber
NOTIFY sip:user@subscriberhost.example.com SIP/2.0
Via: SIP/2.0/TCP server.example.com;branch=z9hG4bKna998sk
From: <sip:alerts@example.com>;tag=ffd2
To: <sip:user@example.com>;tag=xfg9
Call-ID: 1564@subscriberhost.example.com
Event: alerting
Subscription-State: active;expires=599
Max-Forwards: 70
CSeq: 8775 NOTIFY
Contact: sip:server.example.com
Content-Type: application/rss+xml
Content-Length: . . .
<rss version=*2.0*>
</rss>

Moreover, it will be noted that the SIP event model relies on a temporary and renewable subscription. The result of this is that a subscription to an RSS stream initiated from a SIP client is valid only while this client is active. If the user wants to change terminal, the initial client must therefore preferably remain registered on the SIP network and continue to renew the active subscription or subscriptions.

The principles described above can in particular be used in the everyday fields of application of the content syndication technologies, such as personal weblogs, news, weather information, road traffic information, aggregation of contents originating from different feeds, and so on.

Furthermore, the compatibility of the principles of the invention with the SIP protocol opens the way to applications implementing synergies with instant messaging clients or SIP telephony clients. As an example, the concept of contact lists supported by most instant messaging software can be used to manage a global subscription to the online weblogs of a group of friends.

1. A method for warning a user provided with at least one terminal on modification of a content conforming to a content syndication technology in a communication system supporting a session initiation and notification protocol and including a warning server and a content server, the method comprising:
transmitting, from a terminal of the user to the warning server, a subscription message of said protocol, said subscription message identifying a content conforming to said content syndication technology stored on the content server;
receiving on the warning server, from the content server, an indication relating to a modification of said content; and
transmitting a notification message of said protocol to said user, from the warning server, when the warning server has received an indication relating to a modification of said content.

2. The method as claimed in claim 1, in which said notification message is transmitted to the user via at least one of the user's terminals and in which said content is used by a content reader conforming to the content syndication technology within said terminal.

3. The method as claimed in claim 1 or 2, in which said notification message is adapted to at least one protocol supported by at least one of the terminals of the user.

4. A communication system supporting a session initiation and notification protocol, said system comprising a warning server able to communicate with at least one user provided with at least one terminal and a content server able to store at least one content conforming to a content syndication technology, the communication system comprising:
means for receiving on the warning server, from a terminal of the user, a subscription message of said protocol, said subscription message identifying a content conforming to said content syndication technology stored on the content server;
means for receiving on the warning server, from the content server, an indication relating to a modification of said content; and
means for transmitting a notification message of said protocol to said user, from the warning server, when the warning server has received an indication relating to a modification of said content.

5. The communication system as claimed in claim 4, further comprising means for adapting the notification message to at least one protocol supported by at least one of the terminals of the user.

6. A warning server supporting a session initiation and notification protocol, comprising:
a first receiver, wherein the first receiver receives, from a terminal of a user, a subscription message of said protocol, said subscription message identifying a content conforming to a content syndication technology stored on a content server;
a second receiver, wherein the second receiver receives, from the content server, an indication relating to a modification of said content; and
a transmitter, wherein the transmitter transmits a notification message of said protocol to said user when said warning server has received an indication relating to a modification of said content.

7. A computer program capable of being implemented on a warning server, said computer program comprising code instructions which, when run on said warning server, performs the steps of:
receiving, from a terminal of a user, a subscription message of said protocol, said subscription message identifying a content conforming to a content syndication technology stored on a content server;
receiving, from the content server, an indication relating to a modification of said content; and
transmitting a notification message of said protocol to said user when said warning server has received an indication relating to a modification of said content.
